(19) United States
(12) Patent Application Publication
(10) Pub. No.: US 2002/0080989 A1
(43) Pub. Date: Jun. 27, 2002

(54) Hands free microphone and earphone

(76) Inventor: Hong Chi-Lin, Taipei (TW)

Correspondence Address: HONG Chi-Lin, P.O. Box 82-144, Taipei, TW

(21) Appl. No.: 09/742,227

(22) Filed: Dec. 22, 2000

(51) Int. Cl. H04R 25/00

(52) U.S. Cl. 381/374; 381/370; 381/381

(57) ABSTRACT

The present invention relates to a hands free microphone and earphone comprising an ear-hook device and an earpiece. One end of the ear-hook device is provided with a ball-like protruded section, and the circumferential edge thereof has a recessed T-shaped slot, and the circumferential edge of the earpiece is appropriately provided with a mounting section with a protruded peg mounted at the inner wall such that the protruded peg can slide within the T-shaped slot. Thus, when the protruded section and the mounting section are formed integrally as one unit, the earpiece can be rotated or swing in an indefinite angle. Due to the restriction of the protruded peg, the signal wire will not be broken because of excessive winding. Thus in application, the user can be comfortably used the earpiece and an excellent reception quality is obtained.

### BACKGROUND OF THE INVENTION

(a) Technical Field of the Invention

The present invention relates to a hands free microphone and earphone, and in particular, a microphone and earphone with an earpiece, which can be comfortably mounted in the ear and can be adjusted to an appropriate angle to fit the ears, and provides good quality of sound reception.

(b) Description of the Prior Art In order to provide convenient personal communication, a microphone and earphone device is normally used so that the user can speak to the microphone and hear incoming message/sound via the earphone.

FIG. 1 shows a conventional hands free microphone and earphone, wherein the earpiece 2 is a closed type single side earphone and it is mounted to the ear. The earpiece 2 is connected to the microphone by wire, and the surface of the microphone 11 is provided with output audio holes 12 at appropriate position thereon. In application, the earpiece 2 is mounted into the ear and the wire connected to the microphone is hanging down in front the mouth of the user. Thus, the user can use the microphone 11 in association with the earpiece 2 so as to provide convenient communication.

However, there are drawbacks found in this conventional hands free microphone and earphone as follows:

(1) The earpiece is a closed-type single side earphone, and in application, the single side has to directly mount to the ear in order to provide good sound reception. Due to the circular shape of the earphone, it can be easily slid off from the ear and the reception quality is poor.

(2) The earpiece is mounted at the ear and after a long period of wearing it, it is uncomfortable to the ears of the user.

In view of the above, the conventional hands free microphone and earphone has drawbacks, which need to be improved. Accordingly, it is a main object of the present invention to provide an improved structure of a hands free microphone and earphone, allowing excellent reception and providing comfortable wearing to the ears of the user.

### SUMMARY OF THE INVENTION

Accordingly, it is an object of the present invention to provide a hands free microphone and earphone, wherein the drawbacks of the conventional hands free microphone and earphone are mitigated.

Yet another object of the present invention is to provide a hands free microphone and earphone, wherein circumferential edge of the earpiece is provided with a circular hollow mounting section for the engagement of the protruded portion of the ear-hook device. The inner wall of the mounting section has a protruded peg corresponding to the T-shaped slot and sidably within the slot. The inner face of the mounting section is provided with a passage (not shown) to allow the passing through of the signal wires so that the wires are connected to the earpiece.

A further object of the present invention is to provide a hands free microphone and earphone wherein the protruded section and the mounting section are provided with a T-shaped slot and the protruded peg to appropriate restriction, and the earpiece can rotate to left and right in about 60 degree (a total of 60 degree).

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional hands free microphone and earphone structure.

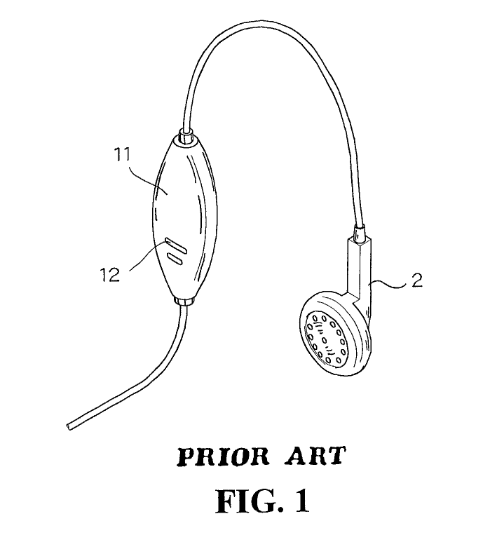

FIG. 2 is a perspective exploded view of a preferred embodiment of the hands free microphone and earphone of the present invention.

FIG. 3 is a combination view of the preferred embodiment of the hands free microphone and earphone of the present invention.

FIG. 4 is a sectional view of the preferred embodiment of the hands free microphone and earphone of the present invention.

FIG. 5 is a partial sectional view of the preferred embodiment of the hands free microphone and earphone of the present invention.

FIGS. 6A and 6B are schematic views showing the left and right rotation of the earphone of the preferred embodiment of the present invention.

FIGS. 7A and 7B are schematic views showing the up and down swinging of the earphone of the preferred embodiment of the present invention.

FIG. 8 is an actual mode of the present preferred embodiment of the present invention.

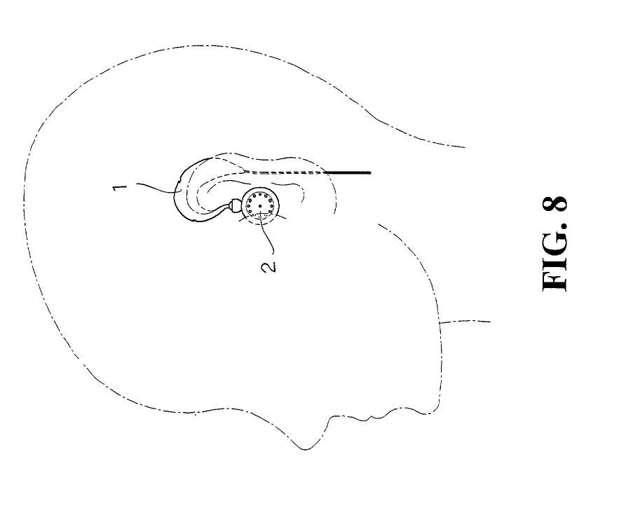

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

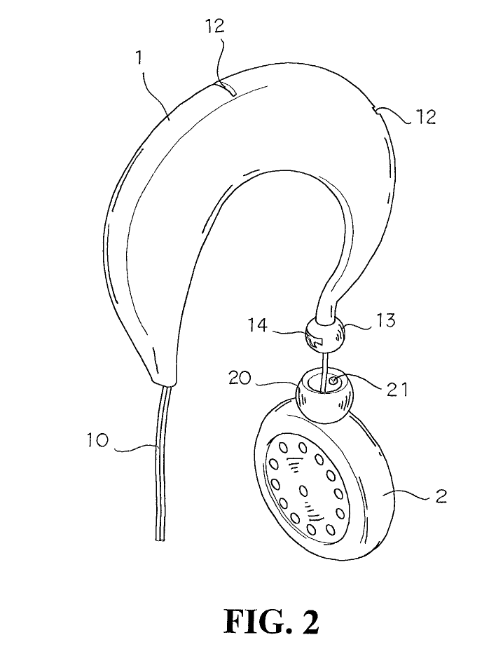

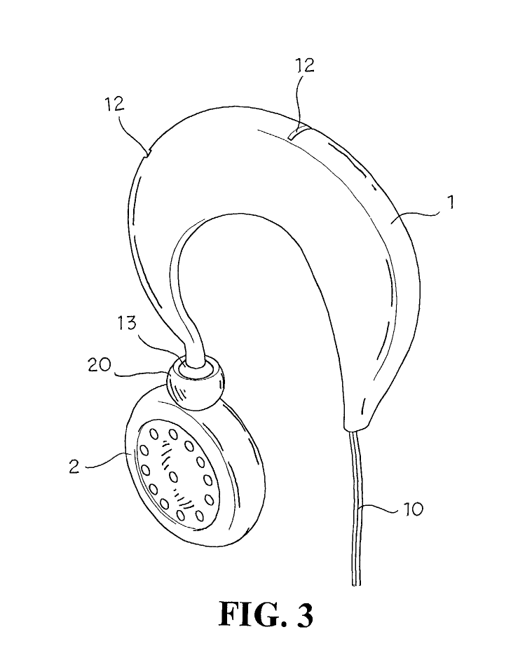

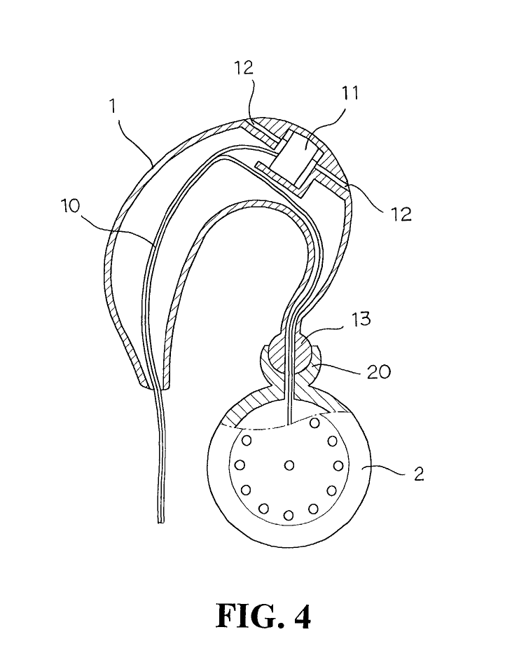

Referring to FIGS. 2 and 3, there is shown an improved structure of a hands free microphone and earphone comprising an ear-hook device 1 having an earpiece 2, wherein the ear-hook device 1 (as shown in FIGS. 2 and 4) is flexible with arch-shaped contour to meet ergonomical requirement with a retraction elastic body towards the two ends. The elastic body has a hollow interior mounted with signal wire 10. The arch-shaped protruded section of the ear-hook device 1 is provided with a high sensitive microphone 11, and the surface of the protruded section is provided with a plurality of audio holes 12, facilitating audio reception and to provide excellent sound reception. One end of the ear-hook device 1 is a ball shaped protruded section 13, and the circumferential edge is provided with a recessed T-shaped slot 14. The signal wire 10 passes through the entire ear-hook device 1 connected to the microphone 11, and is extended to the two ends of the ear-hook device 1 so as to individually connect to the host phone and the earpiece 2.

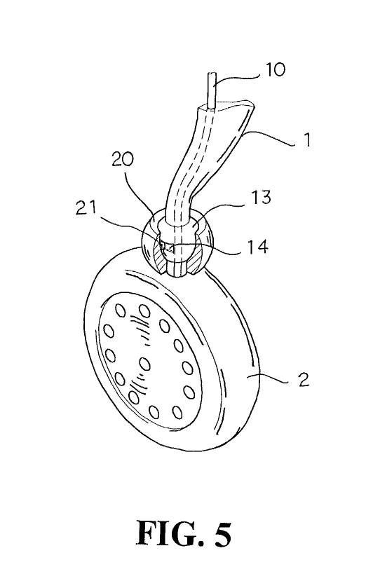

In accordance with the present invention, the earpiece 2 is an opened type earphone with dual sides to emit sound, as shown in FIGS. 2 and 5. The circumferential edge of the earpiece 2 is provided with a circular hollow mounting section 20 for the engagement of the protruded portion 13 of the ear-hook device 1. The inner wall of the mounting section 20 has a protruded peg 21 corresponding to the T-shaped slot 14 and slidably within the slot 14. The inner face of the mounting section 20 is provided with a passage (not shown) to allow the passing through of the signal wires so that the wires are connected to the earpiece 2. As shown in FIG. 3, a complete hands free microphone and earphone structure is formed.

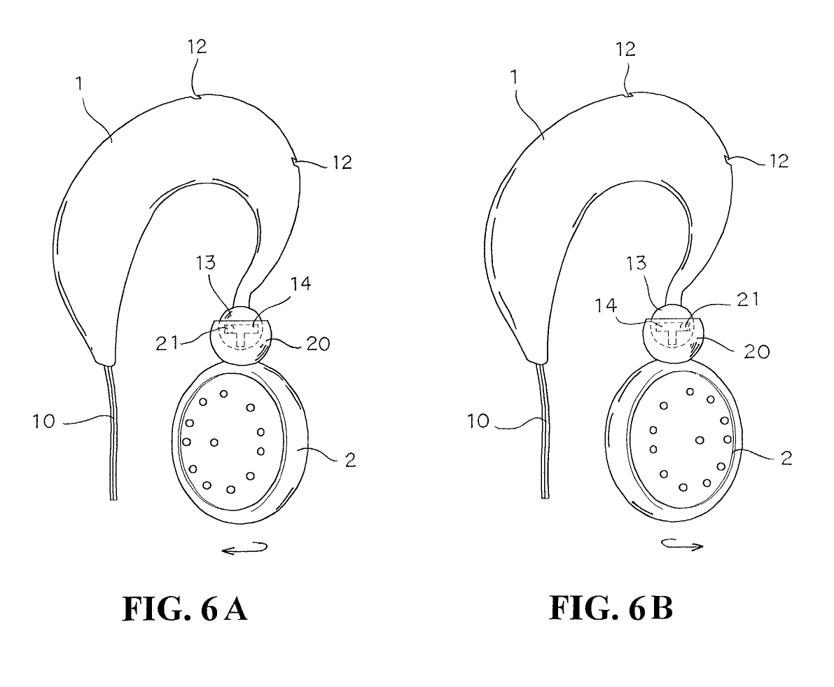

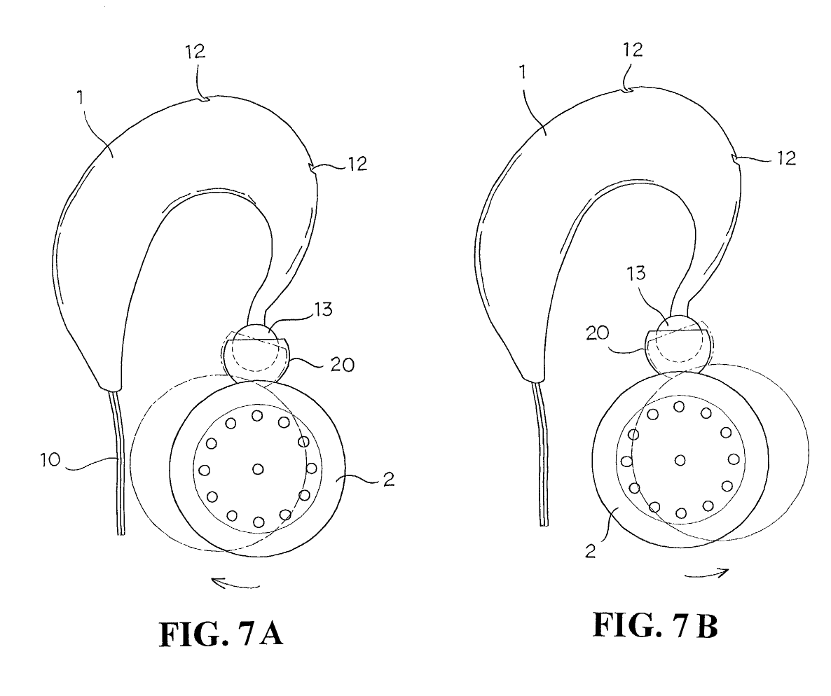

Referning to FIGS. 6A, 6B, 7A and 7B, the earpiece 2 is rotatable at any angle about the ear-hook device 1. As the earpiece 2 is mounted to the protruded section 13 at one end of the ear-hook device 1 by means of the mounting section 20, the earpiece 2 can be rotated or swing in any angle. As a result, in application, the earpiece 2 is allowed to be used for the right ear or for the left ear. As there is signal wire 10 connecting to the earpiece 2 and the ear-hook device 1 and in order to avoid excessive rotation which may damage the signal wire 10, the protruded section 13 and the mounting section 20 are provided with a T-shaped slot 14 and the protruded peg 21 to provide appropriate restriction of rotation of the earpiece 2, and the earpiece 2 can rotate to left and right in about 60 degree (a total of 60 degree). Thus, this degree allows left and right rotation.

In accordance with the present invention, there are advantages as follows:

(1) Comfortable and convenient in wearing the earpiece. As the ear-hook device is made from flexible elastic body and the entire design is ergonomically mounted to the ears, no uncomfortable feeling is caused to the ears.

(2) Good quality reception

As the earpiece can be optionally adjusted based on the shape and size of the ear, the earpiece can be adjusted to a best position to provide excellent quality reception.

(3) Interchangeability

As the earpiece has dual sides, opened type of circular earphone and is in associated with the adjustable mounting structure, it can be employed either in the left ear or right ear.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a hands free microphone and earphone comprising
(a) an ear-hook device for mounting to the ear of the user and one end of the ear-hook device being a ball-like protruded section and the circumferential edge of the protruded section being a recessed T-shaped slot; and
(b) an earpiece having circumferential edge being appropriately mounted with a hollow mounting section and the inner wall of the mounting section being a protruded peg.

2. An improved structure of a hands free microphone and earphone as set forth in claim 1, wherein the ear-hook device has good flexibility with arch shape towards the two ends thereof and is made from elastic material.

3. An improved structure of a hands free microphone and earphone as set forth in claim 1, wherein a high sensitive microphone is provided at an appropriate position within the ear-hook device, and the corresponding lateral surface is provided with a plurality of audio holes so as to conveniently obtain excellent sound reception.

4. An improved structure of a hands free microphone and earphone as set forth in claim 1, wherein the dual sides of the earpiece are opened type circular earphone.
